(19) United States
(12) Patent Application Publication
(10) Pub. No.: US 2024/0409476 A1
(43) Pub. Date: Dec. 12, 2024

(54) PROCESS FOR PRODUCING AN NPK FERTILISER CONTAINING POTASSIUM PHOSPHATE AND AMMONIUM PHOSPHATE

(71) Applicant: FLECHSIG PATENT COMPANY LLC, Cham (CH)

(72) Inventors: Thomas FLECHSIG, Edlibach (CH); Frank FLECHSIG, Wohlen (CH)

(21) Appl. No.: 18/717,109

(22) PCT Filed: Dec. 8, 2021
(86) PCT No.: PCT/EP2021/084769

§ 371 Date: Jun. 6, 2024

(51) Int. Cl. C05B 7/00; C05G 5/23

(52) U.S. Cl. CPC C05B 7/00; C05G 5/23

(57) ABSTRACT

The present invention relates to a process for producing a liquid NPK fertiliser, which is characterised in that the educts K₂CO₃ or KHCO₃, NH₄HCO₃ and H₃PO₄ are reacted in aqueous solution to form potassium and ammonium phosphates, in particular to form K₃PO₄ and (NH₄)₃PO₄, wherein the reaction takes place in a plurality of steps and comprises at least one exothermic reaction and at least one endothermic reaction, and wherein the temperature of the reaction is controlled by regulating the added amount and rate of addition of the respective educts in the various steps such that the reaction mixture is kept in a desired temperature range, throughout the entire reaction without any external cooling or heating devices being required to control the temperature of the reaction.

### BACKGROUND OF THE INVENTION

A plurality of processes for producing NPK fertilisers, i.e. plant fertilisers containing at least the nutrient elements nitrogen, phosphorus and potassium, are known in the prior art.

The simplest approach is to produce various individual components, each containing at least one of the cited nutrient elements, and to subsequently mix them to produce the desired NPK fertiliser.

Another approach aims to produce all the required individual components at the same time. For example, the Chinese patent application CN210595276 U describes a production system for the joint production of monoammonium phosphate and potassium hydrogen phosphate, in which potassium chloride, ammonium hydrogen carbonate and phosphoric acid are used as starting materials. The Chinese patent application CN110423144 discloses a water-soluble NPK fertiliser, characterised in that the main component thereof is dipotassium hydrogen phosphate, which fertiliser is produced by reacting monoammonium phosphate and potassium carbonate in a molar ratio of 2:1.

In these processes—as in other conventional processes for the production of NPK fertilisers or individual components thereof—it is necessary to control the reaction temperatures by cooling (in the case of exothermic reactions) or heating (in the case of endothermic reactions) and to keep them within suitable ranges. These measures increase production costs and have a negative impact on the environment due to the associated energy consumption.

Furthermore, many of the processes known in the prior art are complex in terms of equipment (e.g. the production system described in the above patent application CN210595276 U) and/or are associated with relatively long production times.

Against this background, a main object of the present invention is to provide an improved process for producing an NPK fertiliser, with which the disadvantages of the prior art are avoided or considerably reduced.

According to the invention, this object is solved by providing the process according to claim 1. More specific aspects and preferred embodiments of the invention are the subject matter of the further claims.

### DESCRIPTION OF THE INVENTION

The present invention is based on the surprising finding that by coupling and precisely coordinating suitable endothermic and exothermic reactions, it is possible to produce an NPK fertiliser having all the required components in one reaction mixture without having to use any additional cooling or heating devices to control the temperature of the reaction.

The process according to claim 1 for producing a liquid NPK fertiliser containing at least the nutrient elements nitrogen, phosphorus and potassium is characterised in that the educts K₂CO₃ or KHCO₃, NH₄HCO₃ and H₃PO₄ are reacted in aqueous solution to form potassium and ammonium phosphates, in particular to form H₃PO₄ and (NH₄)₃PO₄, wherein the reaction takes place in a plurality of steps and comprises at least one exothermic reaction and at least one endothermic reaction, and wherein the temperature of the reaction is controlled by regulating the added amount and rate of addition of the respective educts in the various steps such that the reaction mixture is kept in a desired temperature range throughout the entire reaction.

In a more specific embodiment, the process according to the invention is characterised in that the at least one exothermic reaction comprises the reaction of K₂CO₃ with H₂O to form KHCO₃ and KOH and/or the reaction of KHCO₃ with H₃PO₄ to form K₃PO₄, CO₂ and H₂O according to the following reaction equations (1), (2) and (3), and the at least one endothermic reaction comprises or constitutes the reaction of NH₄HCO₃ with H₃PO₄ to form (NH₄)₃PO₄, CO₂ and H₂O according to the following reaction equation (4).

3K₂CO₃+3H₂O→3KHCO₃+3KOH (1)

3KHCO₃+3KOH+2H₃PO₄→2K₃PO₄+6H₂O+3CO₂ (2)

3KHCO₃+1H₃PO₄→1K₃PO₄+3H₂O+3CO₂ (3)

3NH₄HCO₃+1H₃PO₄→1(NH₄)₃PO₄+3H₂O+3CO₂ (4)

The person skilled in the art will understand that the main products of these reactions are salts which, under the reaction conditions in aqueous solution, are in ionic form.

Unless specifically stated otherwise, range specifications in this application include the respective limit values.

The reaction mixture is typically kept in a temperature range of 5° C. to 50° C., preferably of 20° C. to 50° C., throughout the entire reaction. If the temperature in the reaction mixture exceeds the upper limit of 50° C., foaming becomes too intense and the reaction gets out of control. At a temperature below 20° C. and in particular below 5° C., the reaction is much slower and the solubility of some reactants, in particular of NH₄HCO₃, is greatly reduced.

In the last step of the process according to the invention, the pH of the reaction mixture is preferably adjusted to a value in the range of 6.5 to 7.3, preferably in the range of 6.5 to 7.1, particularly preferred in the range of 6.5 to 6.9.

The wording “potassium and ammonium phosphates” as used herein basically includes all potassium and ammonium phosphates in ionic form that can be present in aqueous solution under the pH conditions and molar ratios of the process according to the invention. These are in particular K₃PO₄ and K₂HPO₄, (NH₄)₃PO₄ and (NH₄)₂HPO₄.

At a pH of approximately 8.5 or higher, only K₃PO₄ and (NH₄)₃PO₄ will generally be present, whereas at a pH in the range of 6.5 to 7.5, a mixture of K₃PO₄ and K₂HPO₄ as well as a mixture of (NH₄)₃PO₄ and (NH₄)₂HPO₄ will be present. After adjusting the pH to a final value of 6.5 to 7.3, the mixing ratios are typically in a range of approximately 45% to 55% K₃PO₄ to approximately 55% to 45% K₂HPO₄, and approximately 45% to 55% (NH₄)₃PO₄ to approximately 55% to 45% (NH₄)₂HPO₄.

In a more specific embodiment, the process according to the invention comprises at least the following steps:
a) Mixing a first dose of K₂CO₃ or KHCO₃ in water whilst stirring, the temperature of the reaction mixture being kept at a maximum temperature of 50° C. by regulating the added amount and rate of addition, then mixing in a first dose of NH₄HCO₃ and subsequently mixing in a first dose of H₃PO₄, the temperature of the reaction mixture being kept at a temperature of at least 5° C., preferably of at least 20° C., by regulating the added amount and rate of addition of NH₄HCO₃ and H₃PO₄;
b) Mixing in a further dose of each of K₂CO₃ or KHCO₃, H₃PO₄ and NH₄HCO₃ in this order, the temperature of the reaction mixture being kept in the range of 5° C. to 50° C., preferably in the range of 20° C. to 34° C., by regulating the added amount and rate of addition of the respective educts;
c) Repeating step b) until the used total amounts of K₂CO₃ or KHCO₃ and NH₄HCO₃ have been added;
d) Optionally adding a further dose of H₃PO₄ until the total amounts of K₂CO₃ or KHCO₃, NH₄HCO₃ and H₃PO₄ used in steps a) to d) correspond to a predetermined molar ratio of K₂CO₃ or KHCO₃:NH₄HCO₃:H₃PO₄;
e) Adding further H₃PO₄ until the pH of the reaction mixture has reached a value in the range of 6.5 to 7.3.

In step a), the concentration of K₂CO₃ or KHCO₃ is typically in the range of 0.05 to 0.2 mol/l water, preferably in the range of 0.1 to 0.15 mol/l water, the concentration of NH₄HCO₃ is in the range of 0.07 to 0.2 mol/l water, preferably in the range of 0.1 to 0.15 mol/l water, and the concentration of H₃PO₄ is in the range of 0.3 to 0.75 mol/l water, preferably in the range of 0.1 to 0.15 mol/l water.

In step a), the first dose of K₂CO₃ or KHCO₃ is typically 5 to 20% of the total amount used, preferably 10 to 15% of the total amount used, the first dose of NH₄HCO₃ is 7 to 20% of the total amount used, preferably 10 to 15% of the total amount used, and the first dose of H₃PO₄ is 30 to 75% of the total amount used in steps a) to d), preferably 50 to 60% of the total amount used.

Furthermore, in step a), the molar ratio of K₂CO₃ or KHCO₃:NH₄HCO₃:H₃PO₄ is usually in the range of 0.05 to 02:0.07 to 0.2:0.3 to 0.75, preferably in the range of 0.1 to 0.15:0.1 to 0.15:0.5 to 0.6.

Step b) is repeated at least once until step c) is completed, but can also be repeated more often, for example 2 to 40 times or 2 to 5 times, typically 12 to 25 times. By repeating step b) more often with smaller portions of the respective educts, more precise temperature control can be achieved.

The molar ratio K₂CO₃:NH₄HCO₃:H₃PO₄, which results from the total amounts of K₂CO₃, NH₄HCO₃ and H₃PO₄ used in steps a) to d), may vary in the range of 0.8 to 1.2:0.8 to 1.2:0.8 to 1.2, but approximately equimolar ratios of the educts in the range of 0.95 to 1.05:0.95 to 1.05:0.95 to 1.05 are preferred, and a ratio of approximately 1:1:1 is particularly preferred.

The molar ratio KHCO₃:NH₄HCO₃:H₃PO₄, which results from the total amounts of KHCO₃, NH₄HCO₃ and H₃PO₄ used in steps a) to d) if KHCO₃ is respectively used instead of K₂CO₃ in this embodiment of the process according to the invention, may vary in the range of 2.4 to 3.6:2.4 to 3.6:1.6 to 2.4, but ratios of the educts in the range of 2.85 to 3.15:2.85 to 3.15:1.9 to 2.1 are preferred, and a ratio of approximately 3:3:2 is particularly preferred.

The addition of a further dose of H₃PO₄ in step d) could possibly be omitted if the total amounts of K₂CO₃ or KHCO₃, NH₄HCO₃ and H₃PO₄ used in steps a) to c) already correspond to a predetermined molar ratio of K₂CO₃ or KHCO₃:NH₄HCO₃:H₃PO₄, in particular a molar ratio as specified in the previous paragraphs. However, this embodiment of the process according to the invention preferably also includes step d).

In the last step of this variant of the process according to the invention, i.e. usually in step e), additional H₃PO₄ is added (typically approximately 95% to 100% of the total amount used in steps a) to d)) until the pH of the reaction mixture has reached a value in the range of 6.5 to 7.3, preferably in the range of 6.5 to 7.1, particularly preferred in the range of 6.5 to 6.9.

Advantageously, all the steps of this variant of the process according to the invention, including the adjustment of the pH of the reaction mixture in the last step, are generally completed within a period of 1 to 2 hours. Typically, the duration of step a) is approximately 10 min, the duration of steps b) to d) is approximately 45 to 85 min, and the duration of step e) is approximately 5 to 25 min.

In another specific embodiment, the process according to the invention comprises at least the following steps:
a) Adding a first dose of K₂CO₃ or KHCO₃, preferably of K₂CO₃, to an aqueous solution of H₃PO₄ whilst stirring, the temperature of the reaction mixture being kept at a maximum temperature of 50° C. by regulating the added amount and rate of addition, then mixing in a first dose of NH₄HCO₃, the temperature of the reaction mixture being kept at a temperature of at least 5° C., preferably of at least 20° C., by regulating the added amount and rate of addition of NH₄HCO₃;
b) Mixing in a further dose of K₂CO₃ or KHCO₃, NH₄HCO₃ and optionally H₃PO₄ in this order, the temperature of the reaction mixture being kept in the range of 5° C. to 50° C., preferably in the range of 20° C. to 34° C., by regulating the added amount and rate of addition of the respective educts;
c) Repeating step b) until the total amounts of K₂CO₃ or KHCO₃, NH₄HCO₃ and H₃PO₄ used in steps a) to c) correspond to a predetermined molar ratio of K₂CO₃ or KHCO₃:NH₄HCO₃:H₃PO₄;
e) Adding further H₃PO₄ until the pH of the reaction mixture has reached a value in the range of 6.5 to 7.3.

In step a), the concentration of H₃PO₄ is typically in the range of 0.3 to 0.75 mol/l water, preferably in the range of 0.4 to 0.6 mol/l water, the concentration of K₂CO₃ or KHCO₃ is in the range of 0.05 to 0.2 mol/l reaction mixture, preferably in the range of 0.1 to 0.15 mol/l reaction mixture, and the concentration of NH₄HCO₃ is in the range of 0.07 to 0.2 mol/l reaction mixture, preferably in the range of 0.1 to 0.15 mol/l reaction mixture.

In step a), the first dose of K₂CO₃ or KHCO₃ is typically 5 to 20% of the total amount used, preferably 10 to 15% of the total amount used, the first dose of NH₄HCO₃ is 7 to 20% of the total amount used, preferably 10 to 15% of the total amount used, and the first dose of H₃PO₄ is 30 to 100% of the total amount used in steps a) to c), preferably 50 to 60% of the total amount used.

Furthermore, in step a), the molar ratio of K₂CO₃ or KHCO₃:NH₄HCO₃:H₃PO₄ is usually in the range of 0.05 to 02:0.07 to 0.2:0.3 to 0.75, preferably in the range of 0.1 to 0.15:0.1 to 0.15:0.5 to 0.6.

Step b) is repeated at least once until step c) is completed, but can also be repeated more often, for example 2 to 40 times or 2 to 5 times, typically 12 to 25 times. By repeating step b) more often with smaller portions of the respective educts, more precise temperature control can be achieved.

The addition of a further dose of H₃PO₄ in step b) or c) may be omitted if the amount of H₃PO₄ used in step a) and the total amounts of K₂CO₃ or KHCO₃ and NH₄HCO₃ used in steps b) to c) already correspond to a predetermined molar ratio of K₂CO₃ or KHCO₃:NH₄HCO₃:H₃PO₄, in particular a molar ratio as specified in the following paragraphs. This embodiment is described in Example 2.

The molar ratio K₂CO₃:NH₄HCO₃:H₃PO₄, which results from the total amounts of K₂CO₃, NH₄HCO₃ and H₃PO₄ used in steps a) to c), may vary in the range of 0.8 to 1.2:0.8 to 1.2:0.8 to 1.2, but approximately equimolar ratios of the educts in the range of 0.95 to 1.05:0.95 to 1.05:0.95 to 1.05 are preferred, and a ratio of approximately 1:1:1 is particularly preferred.

The molar ratio KHCO₃:NH₄HCO₃:H₃PO₄, which results from the total amounts of KHCO₃, NH₄HCO₃ and H₃PO₄ used in steps a) to c) if KHCO₃ is respectively used instead of K₂CO₃ in this variant of the process according to the invention, may vary in the range of 2.4 to 3.6:2.4 to 3.6:1.6 to 2.4, but ratios of the educts in the range of 2.85 to 3.15:2.85 to 3.15:1.9 to 2.1 are preferred, and a ratio of approximately 3:3:2 is particularly preferred.

In the last step d) of this variant of the process according to the invention, additional H₃PO₄ is added (typically approximately 90% to 100% of the total amount used in steps a) to c)) until the pH of the reaction mixture has reached a value in the range of 6.5 to 7.3, preferably in the range of 6.5 to 7.1, particularly preferred in the range of 6.5 to 6.9.

Advantageously, all the steps of this variant of the process according to the invention, including the adjustment of the pH of the reaction mixture in the last step, are generally completed within a period of 1 to 2 hours. Typically, the duration of step a) is approximately 10 min, the duration of steps b) to c) is approximately 45 to 85 min, and the duration of step d) is approximately 5 to 25 min.

A further particular advantage of the claimed process is that, due to the coupling and coordination of exothermic and endothermic partial reactions according to the invention, no external cooling or heating devices are required to control the temperature of the reaction.

The process according to the invention is typically carried out in a closed system and the CO₂ formed as a by-product during the reaction is collected and optionally provided for a further use. In this way, environmental pollution by the process according to the invention can be prevented.

The following examples are intended to explain the process according to the invention in more detail, but without limiting the invention to the specific parameters and process conditions of these embodiment examples.

### Example 1

In a stirred vessel having a volume of 15 l, potassium carbonate, ammonium hydrogen carbonate and phosphoric acid were reacted as follows according to the process of the invention to obtain an NPK fertiliser containing tripotassium phosphate and triammonium phosphate.
a) In a first step of the process, the reaction vessel was filled with 9 l of water (temperature 24.8° C.) and then 700 g of K₂CO₃ were mixed in whilst stirring. Intense foaming occurred, the temperature in the reaction vessel increased to 45.6° C. and the pH reached 12.83. After this heating, an endothermic reaction was used for cooling by first mixing in 664 g of NH₄HCO₃ whilst stirring. Intense foaming occurred again, the temperature in the reaction vessel dropped to 40° C. and the pH dropped to 12.3. 242 g of H₃PO₄ (78%) were then added whilst stirring. The temperature dropped further to 25.4° C. and the pH reached 9.78.
b) In the next step of the process, 460 g of K₂CO₃ were added to the reaction mixture whilst stirring. Intense foaming occurred, the temperature in the reaction vessel increased to 38.0° C. and the pH reached 12.5. 322 g of H₃PO₄ (78%) were then added whilst stirring. The temperature dropped again to 32.8° C. and the pH reached 9.98. The subsequent mixing in of a further 409 g of NH₄HCO₃ whilst stirring again led to intense foaming and a drop in temperature to 26.4° C. and a pH of 9.5.
c) 340 g of K₂CO₃ were now added to the reaction mixture whilst stirring. Intense foaming occurred, the temperature in the reaction vessel increased to 30.9° C. and the pH reached 9.8. 436 g of H₃PO₄ (78%) were then added whilst stirring. The temperature stabilised at 31.8° C. and the pH reached 8.9. The subsequent mixing in of a further 247 g of NH₄HCO₃ whilst stirring again led to intense foaming and a drop in temperature to 30.2° C. and a pH of 8.8.
d) After the further addition of 611 of H₃PO₄ (78%) whilst stirring, the temperature stabilised at 30.4° C. and the pH reached 8.5.
e) Subsequently, 436 g of H₃PO₄ (78%) were added whilst stirring to substantially neutralise the reaction mixture and convert hydrogen carbonate into carbonic acid and remove it from the reaction mixture as CO₂. The temperature stabilised at 30.2° C. and the pH reached 7.04. The density of the resulting liquid NPK fertiliser mixture was 1.32 g/cm³.

The following Table 1 summarises the essential reaction parameters of this embodiment example for steps a) to d).

TABLE 1

| | Total | | | | | | | | | | | |
|---|---|---|---|---|---|---|---|---|---|---|---|---|
| Educts | amount (g) | | Order and amount (g) added | | | | | | | | | |
| Water | 9000 | | 9000 | | | | | | | | | |
| K₂CO₃ | 1500 | | 700 | | | 460 | | | 340 | | | |
| NH₄HCO₃ | 1320 | | | 664 | | | | 409 | | | 247 | |
| H₃PO₄ (78%) | 1611 | | | | 242 | | 322 | | | 436 | | 611 |
| Step | | | a | a | a | b | b | b | c | c | c | d |
| pH | | 7.26 | 12.83 | 12.3 | 9.78 | 12.5 | 9.98 | 9.5 | 9.8 | 8.9 | 8.8 | 8.5 |
| Temperature | | 24.8 | 45.6 | 40 | 25.4 | 38 | 32.8 | 26.4 | 30.9 | 31.8 | 30.2 | 30.4 |
| (° C.) | | | | | | | | | | | | |

### Example 2

In a stirred vessel having a volume of 4 l, potassium carbonate, ammonium hydrogen carbonate and phosphoric acid were reacted as follows according to the process of the invention to obtain an NPK fertiliser containing tripotassium phosphate and triammonium phosphate.
a) In a first step of the process, the reaction vessel with 0.7 l water (temperature 22.4° C.) was filled with 359 g of H₃PO₄ (78%) and then 62 g of K₂CO₃ were mixed in whilst stirring. Intense foaming occurred and the temperature in the reaction vessel increased. After this heating, an endothermic reaction was used for cooling by first mixing in 201 g of NH₄HCO₃ whilst stirring. Intense foaming occurred again, the temperature in the reaction vessel dropped to 23.6° C. and the pH increased to 4.7.
b) In the next step of the process, 48 g of K₂CO₃ were added to the reaction mixture whilst stirring. Intense foaming occurred, the temperature in the reaction vessel increased and the pH increased further. The subsequent mixing in of a further 83 g of NH₄HCO₃ whilst stirring again led to intense foaming and a drop in temperature to 23.6° C. and a pH of 8.1.
b) 36.5 g of K₂CO₃ were now added to the reaction mixture whilst stirring. Intense foaming occurred, the temperature in the reaction vessel increased, as did the pH. The subsequent mixing in of a further 168.7 g of NH₄HCO₃ whilst stirring again led to intense foaming and a drop in temperature to 23.6° C. and a pH of 8.5.
d) Addition of phosphoric acid for neutralization: 331 g of H₃PO₄ (78%) were subsequently added whilst stirring to substantially neutralise the reaction mixture and convert hydrogen carbonate into carbonic acid and remove it from the reaction mixture as CO₂. The temperature stabilised at 23.7° C. and the pH reached 6.7. The density of the resulting liquid NPK fertiliser mixture was 1.32 g/cm³.

The following Table 2 summarises the essential reaction parameters of this embodiment example for steps a) to d).

TABLE 2

| | Total | | | | | | | | | |
|---|---|---|---|---|---|---|---|---|---|---|
| Educts | amount (g) | | Order and amount (g) added | | | | | | | |
| Water | 700 | | 700 | | | | | | | |
| K₂CO₃ | 146.5 | | | 62 | | 48 | | 36.5 | | |
| NH₄HCO₃ | 452.7 | | | | 201 | | 83 | | 168.7 | |
| H₃PO₄ (78%) | 690 | | 359 | | | | | | | 331 |
| Step | | | a | a | a | b | b | c | c | d |
| pH | | | | | 4.7 | | 8.1 | | 8.5 | 6.7 |
| Temperature | | 22.4 | | | 23.6 | | 23.6 | | 23.6 | 23.7 |
| (° C.) | | Water | | | | | | | | |

1. A process for producing a liquid NPK fertiliser containing at least the nutrient elements nitrogen, phosphorus and potassium, wherein educts K₂CO₃ or KHCO₃, NH₄HCO₃ and H₃PO₄ are reacted in aqueous solution to form potassium and ammonium phosphates, in particular to form K₃PO₄ and (NH₄)₃PO₄, wherein the reaction takes place in a plurality of steps and comprises at least one exothermic reaction and at least one endothermic reaction, and wherein the temperature of the reaction is controlled by regulating the added amount and rate of addition of the respective educts in the various steps such that the reaction mixture is kept in a desired temperature range throughout the entire reaction.

2. The process according to claim 1, wherein the at least one exothermic reaction comprises the reaction of K₂CO₃ with H₂O to form KHCO₃ and KOH and/or the reaction of KHCO₃ with H₃PO₄ to form K₃PO₄, CO₂ and H₂O, and the at least one endothermic reaction comprises the reaction of NH₄HCO₃ with H₃PO₄ to form (NH₄)₃PO₄, CO₂ and H₂O.

3. The process according to claim 1, wherein the reaction mixture is kept in a temperature range of 5° C. to 50° C. throughout the entire reaction.

4. The process according to to claim 1, wherein the last step of the process, the pH of the reaction mixture is adjusted to a value in the range of 6.5 to 7.3.

5. The process according to claim 1, comprising at least the following steps:
a) mixing a first dose of K₂CO₃ or KHCO₃ in water whilst stirring, the temperature of the reaction mixture being kept at a maximum temperature of 50° C. by regulating the added amount and rate of addition, then mixing in a first dose of NH₄HCO₃ and subsequently mixing in a first dose of H₃PO₄, the temperature of the reaction mixture being kept at a temperature of at least 5° C.; by regulating the added amount and rate of addition of NH₄HCO₃ and H₃PO₄;
b) mixing in a further dose of each of K₂CO₃ or KHCO₃, H₃PO₄ and NH₄HCO₃ in this order, the temperature of the reaction mixture being kept in the range of 5° C. to 50° C., inclusive, by regulating the added amount and rate of addition of the respective educts;
c) repeating step b) until the total amount of K₂CO₃ or KHCO₃ and of NH₄HCO₃ has been added;
d) optionally adding a further dose of H₃PO₄ until the total amounts of K₂CO₃ or KHCO₃, NH₄HCO₃ and H₃PO₄ used in steps a) to d) correspond to a predetermined molar ratio of K₂CO₃ or KHCO₃:NH₄HCO₃:H₃PO₄; and
e) adding further H₃PO₄ until the pH of the reaction mixture has reached a value in the range of 6.5 to 7.3.

6. The process according to claim 5, wherein in step a), the concentration of K₂CO₃ or KHCO₃ is in the range of 1 to 6 mol/l water,
the concentration of NH₄HCO₃ is in the range of 1 to 3 mol/l water, and
the concentration of H₃PO₄ is in the range of 1 to 3 mol/l water.

7. The process according to claim 5, wherein in step a), the first dose of K₂CO₃ or KHCO₃ is 5 to 20% of the total amount used,
the first dose of NH₄HCO₃ is 7 to 20% of the total amount used, and
the first dose of H₃PO₄ is 30 to 75% of the total amount used in steps a) to d).

8. The process according to claim 5, wherein in step a), the molar ratio of K₂CO₃ or KHCO₃:NH₄HCO₃:H₃PO₄ is in the range of 0.05 to 02:0.07 to 0.2:0.3 to 0.75.

9. The process according to claim 5, wherein the molar ratio K₂CO₃:NH₄HCO₃:H₃PO₄ of the total amounts of K₂CO₃, NH₄HCO₃ and H₃PO₄ used in steps a) to d) is in the range of 0.8 to 1.2:0.8 to 1.2:0.8 to 1.2, or the molar ratio KHCO₃:NH₄HCO₃:H₃PO₄, which results from the total amounts of KHCO₃, NH₄HCO₃ and H₃PO₄ used in steps a) to d) if KHCO₃ is respectively used instead of K₂CO₃, is in the range of 2.4 to 3.6:2.4 to 16:1.6 to 2.4.

10. The process according to claim 5, wherein in step e), H₃PO₄ is added until the pH of the reaction mixture has reached a value in the range of 6.5 to 7.1.

11. The process according to claim 1, comprising at least the following steps:
adding a first dose of K₂CO₃ or KHCO₃ to an aqueous solution of H₃PO₄ whilst stirring, the temperature of the reaction mixture being kept at a maximum temperature of 50° C. by regulating the added amount and rate of addition, then mixing in a first dose of NH₄HCO₃, the temperature of the reaction mixture being kept at a temperature of at least 5° C., preferably of at least 20° C., by regulating the added amount and rate of addition of NH₄HCO₃;
b) mixing in a further dose of K₂CO₃ or KHCO₃, NH₄HCO₃ and optionally H₃PO₄ in this order, the temperature of the reaction mixture being kept in the range of 5° C. to 50° C., inclusive, by regulating the added amount and rate of addition of the respective educts;
c) repeating step b) until the total amounts of K₂CO₃ or KHCO₃, NH₄HCO₃ and H₃PO₄ used in steps a) to c) correspond to a predetermined molar ratio of K₂CO₃ or KHCO₃:NH₄HCO₃:H₃PO₄; and
d) adding further H₃PO₄ until the pH of the reaction mixture has reached a value in the range of 6.5 to 7.3.

12. The process according to claim 11, wherein in step a), the concentration of H₃PO₄ is in the range of 0.3 to 1.0 mol/l water;
the concentration of K₂CO₃ or KHCO₃ is in the range of 0.05 mol to 0.2 mol/l reaction mixture; and
the concentration of NH₄HCO₃ is in the range of 0.07 mol to 0.2 mol/l reaction mixture.

13. The process according to claim 11, wherein in step a), the first dose of K₂CO₃ or KHCO₃ is 5 to 20% of the total amount used;
the first dose of NH₄HCO₃ is 7 to 20% of the total amount used; and
the first dose of H₃PO₄ is 30 to 100% of the total amount used in steps a) to c).

14. The process according to claim 11, wherein in step a), the molar ratio of K₂CO₃ or KHCO₃:NH₄HCO₃:H₃PO₄ is in the range of 0.05 to 02:0.07 to 0.2:0.3 to 1.0.

15. The process according to claim 11, wherein the molar ratio K₂CO₃:NH₄HCO₃:H₃PO₄ of the total amounts of K₂CO₃, NH₄HCO₃ and H₃PO₄ used in steps a) to c) is in the range of 0.8 to 1.2:0.8 to 1.2:0.8 to 1.2, or the molar ratio KHCO₃:NH₄HCO₃:H₃PO₄, which results from the total amounts of KHCO₃, NH₄HCO₃ and H₃PO₄ used in steps a) to c) if KHCO₃ is respectively used instead of K₂CO₃, is in the range of 2.4 to 3.6:2.4 to 16:1.6 to 2.4.

16. The process according to claim 11, wherein in step d), H₃PO₄ is added until the pH of the reaction mixture has reached a value in the range of 6.5 to 7.1.

17. The process according to claim 1, wherein all the steps of the process, including the adjustment of the pH of the reaction mixture in the last step, are completed within a period of 1 to 2 hours.

18. The process according to claim 1, wherein no cooling or heating devices are used to control the temperature of the reaction.

19. The process according to claim 1, wherein the process is carried out in a closed system, and CO₂ formed during the reaction is collected.
